(19) United States
(12) Patent Application Publication
(10) Pub. No.: US 2026/0004179 A1
(43) Pub. Date: Jan. 1, 2026

(54) QUANTUM MACHINE LEARNING DEVICES AND METHODS

(71) Applicant: Silicon Quantum Computing Pty Limited, Kensington (AU)

(72) Inventors: Michelle Yvonne Simmons, Kensington (AU); Casey Myers, Kensington (AU); Samuel Keith Gorman, Kensington (AU); Samuel Sutherland, Kensington (AU)

(21) Appl. No.: 18/880,835

(22) PCT Filed: Jul. 5, 2023
(86) PCT No.: PCT/AU2023/050620

§ 371 Date: Jan. 2, 2025

(30) Foreign Application Priority Data
Jul. 5, 2022 (AU) 2022901888

(51) Int. Cl. G06N 10/60; G06N 10/20; G06N 10/40

(52) U.S. Cl. CPC G06N 10/60; G06N 10/20; G06N 10/40

(57) ABSTRACT

Methods and devices for generating quantum features for a machine learning model are disclosed. The method includes: providing a quantum ML device (QMLD) comprising one or more quantum dots, one or more source gates, one or more drain gates, and one or more control gates. The method further includes transforming input data for the machine learning model into first voltages; applying the first voltages to the one or more control gates, and/or source gates, and/or drain gates; applying a second voltage to one or more of the one or more source gates; measuring a signal at one or more of the one or more drain gates; analysing the measured signal to determine values of one or more parameters; and interpreting the values of the one or more parameters as non-linear mappings of the input data to be used for the machine learning model.

### TECHNICAL FIELD

Aspects of the present disclosure are related to quantum processing devices and more particularly to methods and devices for implementing machine learning techniques using such quantum processing devices.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Machine learning (ML) has had a profound impact on our everyday lives, from advancing computational methods in materials design and chemical processes, to pattern recognition for autonomous vehicle transport and cell classification for cancer cell detection. With the advances in computing power approximately following Moore's law and doubling each year, there has been rapid progress in ML algorithms.

To date, ML uses classical computers where computation is performed using binary bits-which can be in one of two different states, 0 or 1. The binary nature of classical computing bits can make them slow and usually multiple bits are required to complete the simplest equations on a classical computer. A quantum computer, on the other hand, performs computation using quantum bits or qubits, which unlike classical bits, can exist in multiple states. A qubit can be in a 0, 1 or a superposition of the two states (called a quantum state). As such, quantum computers can complete algorithms much faster and may need fewer qubits to perform operations. Because of this superiority, it is stipulated that quantum computers will be able to solve ML problems that may be intractable using classical computation.

With this in mind, progress has been made recently to use quantum computers to solve ML problems. This has led to the sub-field of quantum machine learning, where a variety of quantum algorithms (that are performed in part or fully on quantum computers) for ML tasks have been shown to outperform classical algorithms (that are performed on classical computers). However, the performance of such quantum machine learning algorithms can be further improved.

### SUMMARY

According to a first aspect of the present disclosure, there is provided a method for generating quantum features for a machine learning model. The method includes: providing a quantum ML device (QMLD) comprising one or more quantum dots, one or more source gates, one or more drain gates, and one or more control gates. The method further includes transforming input data for the machine learning model into first voltages; applying the first voltages to the one or more control gates, and/or source gates, and/or drain gates; applying a second voltage to one or more of the one or more source gates; measuring a signal at one or more of the one or more drain gates; analysing the measured signal to determine values of one or more parameters; and interpreting the values of the one or more parameters as non-linear mappings of the input data to be used for the machine learning model.

Transforming the input data into voltages may include performing a random transform of the input data, and transforming the random transformed input data into voltages. In other embodiments, transforming the input data into voltages includes directly mapping the input data into voltages. In such embodiments, interpreting the values of the one or more parameters may include combining the values of the one or more parameters as features for the machine learning model.

In some embodiments, transforming the input data into voltages includes combining data points of the input data into pairs, converting the combined data points into combined voltages, and applying the voltages to the one or more control gates comprises applying the combined voltages to the one or more control gates. In such cases, interpreting the values of the one or more parameters includes determining a distance metric or similarity score between the values of the one or more parameters.

In some examples, the quantum ML device includes a plurality of source gates, a plurality of drain gates, and a plurality of control gates and the quantum ML device is used as a quantum random kitchen sinks device.

In other examples, the quantum ML device includes one source gate, a number of drain gates that matches a desired feature dimension, a number of control gates that matches the dimension of the input data, and the quantum ML device is used as a quantum extreme learning machine.

In yet other examples, the quantum ML device includes one source gate, one drain gate, a number of control gates that is two times the dimension of the input data, and the quantum ML device is used as a quantum kernel learning machine.

The method may further include the step of fabricating the quantum ML device. This fabrication step includes: preparing a bulk layer of a semiconductor substrate; preparing a second semiconductor layer; exposing a clean crystal surface of the second semiconductor layer to dopant molecules to produce an array of dopant dots on the exposed surface; annealing the arrayed surface to incorporate the dopant atoms into the second semiconductor layer; and forming the one or more gates, the one or more source leads and the one or more drain leads.

The one or more control gates may be formed in a same plane as the dopant dots. In other examples, a dielectric material may be deposited above the annealed second semiconductor layer and the one or more control gates may be formed above the dielectric material.

In some examples, the dopant dots are phosphorus dots, the second semiconductor layer is silicon-28, and the quantum ML device includes ten quantum dots.

In another aspect of the present disclosure, there is provided a quantum ML device (QMLD). The QMLD includes: one or more quantum dots; one or more source gates; one or more drain gates; and one or more control gates. The quantum ML device is used for generating quantum features for a machine learning model by: applying first voltages, corresponding to input data for the machine learning model, to the one or more control gates, and/or source gates, and/or drain gates; applying a second voltage to one or more of the one or more source gates; measuring a signal at one or more of the one or more drain gates; analysing the measured signal to determine values of one or more parameters; and interpreting the values of the one or more parameters as non-linear mappings of the input data to be used for the machine learning model.

Further aspects of the present disclosure and embodiments of the aspects summarised in the immediately preceding paragraphs will be apparent from the following detailed description and from the accompanying figures.

### BRIEF DESCRIPTION OF THE DRAWINGS

FIG. 1A shows a schematic of a first example donor qubit device.

FIG. 1B shows a schematic of second example donor qubit device.

FIG. 2A shows an example quantum ML device according to aspects of the present disclosure.

FIG. 2B shows examples of three current sources measured at independent drain leads.

FIG. 3 is a flowchart illustrating an example method for quantum ML according to aspects of the present disclosure.

FIG. 4 shows a schematic of an example quantum ML device used as a quantum extreme learning machine according to aspects of the present disclosure.

FIG. 5 shows a schematic of an example quantum ML device used as a quantum kernel learning machine according to aspects of the present disclosure.

FIG. 6 shows a schematic of an example quantum ML device used as a quantum random kitchen sink according to aspects of the present disclosure.

FIG. 7 shows a STM lithography image of a quantum ML device used to evaluate the performance of quantum random kitchen sinks.

FIG. 8 shows a plot of the performance of quantum random kitchen sinks compared to classical random kitchen sinks based on the cosine and triangle functions on the hypersphere data set.

FIG. 9 is a plot of the performance of quantum random kitchen sinks compared to classical random kitchen sinks based on the cosine and triangle functions on the bin packing data set.

FIG. 10 is a plot of the performance of quantum random kitchen sinks compared to classical random kitchen sinks based on the cosine and triangle functions on the diatomic bonds data set.

FIG. 11 shows a STM micrograph of another quantum ML device used to evaluate the performance of quantum random kitchen sinks.

FIG. 12A depicts an ad-hoc dataset.

FIG. 12B depicts a hyperspheres dataset.

FIG. 12C depicts a polynomial root separation dataset.

FIG. 12D depicts example images from a benchmark real dataset.

FIG. 13A is a grid of nine subplots showing the performance of the RKS, RBF, and QRKS models on the hyperspheres, polynomial separation, and ad-hoc datasets as a function of hyper-parameters used to perform the optimization.

FIG. 14A is a plot of the performance of quantum random kitchen sinks (QRKS) compared with three classical models on the polynomial separation dataset.

FIG. 14B is a plot of the performance of QRKS compared with three classical models on the ad hoc dataset.

FIG. 14C is a plot of the performance of QRKS compared with three classical models on the hyperspheres dataset.

FIG. 14D is a table illustrating the performance of QRKS compared with three classical models on the MNIST dataset.

FIG. 14E is a plot showing the performance of QRKS compared with three classical models on the hyperspheres dataset for 22 dimensional data.

FIG. 14F is a plot of the performance of QRKS compared with three classical models on the polynomial separation dataset for 5 dimensional data.

FIG. 14G is a plot of the performance of QRKS compared with three classical models on the ad hoc dataset for 2 dimensional data.

FIG. 15A shows an example response of the quantum ML device to a random binary string input operating as a reservoir at 4 K.

FIG. 15B shows an example response of the quantum ML device to a random binary string input operating as a reservoir at approximately 30 mK.

FIG. 16A is a plot of the memory capacity of the QMLD at 4K when operating as a reservoir.

FIG. 16B is a plot of the memory capacity of the QMLD at approximately 30 mK when operating as a reservoir.

FIG. 16C is a plot of the processing capacity of the QMLD at 4K when operating as a reservoir.

FIG. 16D is a plot of the processing capacity of the QMLD at 4K when operating as a reservoir.

### DETAILED DESCRIPTION

### Overview

As described above, ML algorithms and models are used in almost every technology domain these days to help classify data, predict outcomes, or prescribe solutions. For example, ML algorithms may be utilized to automatically classify emails as spam or not, predict weather patterns or prescribe an action plan based on a given set of input conditions. To achieve these goals, a suitable ML model is first selected (e.g., a binary classification model or a regression model) and then it is trained on some training data. For example, to classify emails a binary classification model may be utilized and the training data may be emails, to predict weather patterns, a regression model may be selected and the training data may be different types of weather phenomena and historical weather data, etc.

On a macro level, a ML model takes an input data vector (\vec{x}) and produces information \vec{y} dependent on how well the model has been trained. For example, a ML model may be trained to take an image as an input and determine whether that image includes a cat or not. In such an example, the ML model is first trained using a set of images. Some of the images may include cats and other images may not. Further, the training data may be labelled such that the model knows which of the images include cats and which images do not. Once the ML model has been trained with sufficient data it is able to classify unlabelled images as cat images or not. The accuracy of such ML models is dependent on a number of factors, including and not limited to: the amount of training data used, the model itself, how well the model has been trained (i.e., the quality and quantity of the training).

One way to enhance the accuracy of a ML model is to use feature engineering. In machine learning, a feature is an individual measurable property or characteristic of a phenomenon. For example, in spam detection algorithms, features may include the presence or absence of certain email headers, the email structure, the language, the frequency of specific terms, the grammatical correctness of the text, etc. Models may use these features to help classify, predict, or prescribe. Feature engineering refers to the process of selecting, manipulating, and transforming raw data to extract features that can be used in training a ML model. Feature engineering generally leverages data from a training dataset to create new features. This set of new features can then be used to train the ML model with the goal of simplifying and speeding up the overall computation.

One example technique for engineering features is referred to as the kernel method or kernel trick. This method generates features for algorithms depending only on the inner product between pairs of input data points. It relies on the observation that any positive semi-definite function K(xᵢ, xⱼ) with xᵢ, xⱼ∈ [symbol] defines an inner product in a transformed space K(xᵢ, xⱼ)= [symbol] ϕ(xᵢ), ϕ(xⱼ) [symbol] , where ϕ(xᵢ) and ϕ(xⱼ) are the transformations of the data points xᵢ and xⱼ, respectively. Other methods for engineering features include the random kitchen sink method, which as the name suggests, selects a subset of features from a feature set at random, and uses these features to train a corresponding ML model.

As discussed previously, classical computers will soon reach a point where quantum mechanical effects will hinder further developments and quantum computers will have to be used to perform computations that classical computers will not be able to perform. However, the caveat with quantum computation is that the physical devices currently being built are still in the so-called noisy intermediate-scale quantum (NISQ) era, where it is not possible to implement fully fault tolerant quantum algorithms. Instead, these NISQ systems can be used to solve specific problems of practical importance. Such quantum systems that are purpose-built (or hard coded) to perform one or more specific problems are called analogue quantum computers or analogue quantum processors.

Such analogue quantum computers or processors have recently been built to simulate the Fermi-Hubbard model, magnetism, and topological phases.

The present disclosure introduces a quantum ML device for performing quantum machine learning with classical input and output-exploiting semiconductor quantum dots and simulating a Fermi-Hubbard model Hamiltonian. With minimal changes to the quantum ML device, the device can be used as a quantum extreme learning machine, a quantum kernel learning machine, and as quantum random kitchen sinks. It is found that the presently disclosed quantum ML device and associated quantum ML techniques to engineer features performs significantly better than the corresponding classical computation techniques.

### Example System

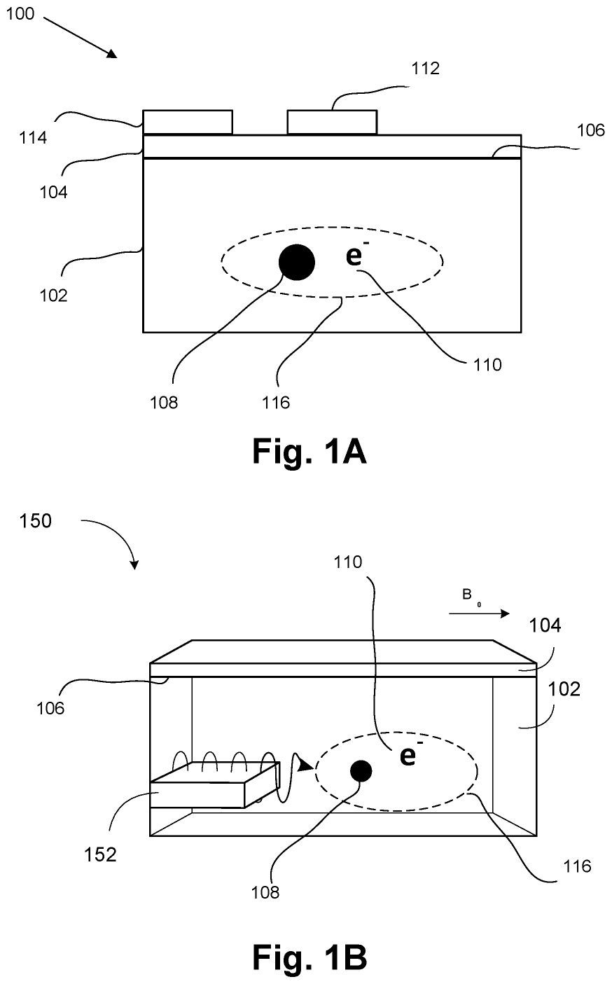

FIG. 1A shows an example semiconductor quantum dot device 100 that can be implemented in the quantum ML device of the present disclosure. As shown in the figure, the quantum dot device 100 includes a semiconductor substrate 102 and a dielectric 104. In this example, the substrate is isotopically purified silicon (Silicon-28) and the dielectric is silicon dioxide. In other examples, the substrate may be silicon (Si). Where the substrate 102 and the dielectric 104 meet an interface 106 is formed. In this example, it is a Si/SiO₂ interface. To form the quantum dot, a donor atom 108 is located within the substrate 102. The quantum dot is defined by the Coulomb potential of the donor atom. The donor atom 108 can be introduced into the substrate using nano-fabrication techniques, such as hydrogen lithography provided by scanning-tunnelling-microscopes, or industry-standard ion implantation techniques. In some examples, the donor atom 108 may be a phosphorus atom in a silicon substrate and the quantum dot may be referred to as a Si:P quantum dot.

In the example depicted in FIG. 1A, the quantum dot includes a single donor atom 108 embedded in the silicon-28 crystal. In other examples, the quantum dot may include multiple donor atoms embedded in close proximity to each other.

Gates 112 and 114 may be used to tune the electron filing on the quantum dot 100. For example, an electron 110 may be loaded onto the quantum dot by a gate electrode, e.g., 112. The physical state of the electron 110 is described by a wave function 116—which is defined as the probability amplitude of finding an electron in a certain position. Donor qubits in silicon rely on using the potential well naturally formed by the donor atom nucleus to bind the electron spin.

FIG. 1B shows another example semiconductor quantum dot device 150 that can be implemented in the quantum ML device of the present disclosure. This device is similar to the quantum dot device 100 shown in FIG. 1A, a difference being the placement of the gates. In FIG. 1A, the gates 112, 114 were placed on top of the dielectric 104. In this example, the gate 152 is located within the semiconductor substrate 102. In some embodiments, the gate 152 is placed in the same plane as the donor dot 108. Such in-plane gates may be connected to the surface of the substrate via metal vias (not shown). Voltages may be applied to gate electrode 152 to confine one or more electrons 110 in the Coulomb potential of the donor atom 108. In some examples, a quantum dot device may include a gate located within the semiconductor substrate 102 and a gate located on top of the dielectric 104.

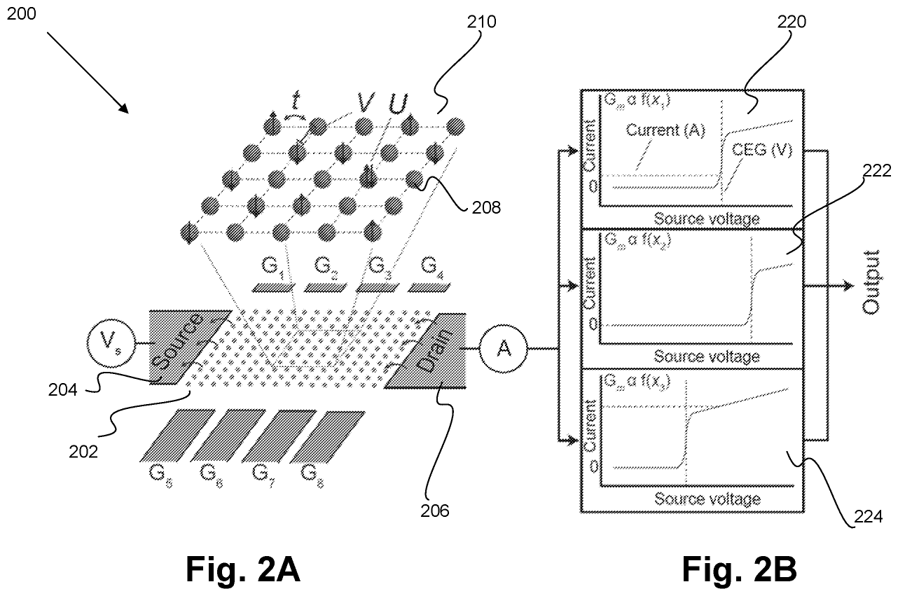

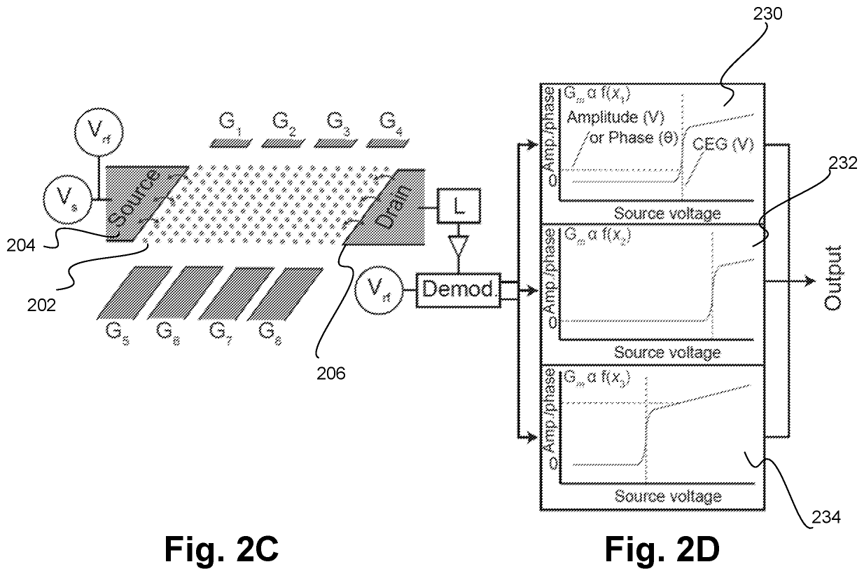

FIG. 2A shows an example quantum ML device (QMLD) 200 according to aspects of the present disclosure. The QMLD 200 comprises a donor quantum dot array 202, a source 204, a drain 206, and a plurality of input gate electrodes G1-G8. In one example, the quantum dot array 202 comprises an array of donor quantum dots 208, where each quantum dot 208 is similar to that shown in FIG. 1A and/or FIG. 1B. The inset 210 in FIG. 2A shows a zoomed in view of a 5×5 section of the quantum dot array 202. As seen in the inset, the quantum dots 208 are arranged in a square lattice. Each of the circles in the inset represents a quantum dot, and the arrows in the quantum dots represent the spin of electrons coupled to donor atoms of the quantum dots.

It will be appreciated that the quantum dots 208 in the array need not be placed in a square lattice formation. Instead, the quantum dots 208 can be arranged in an array of any shape without departing from the scope of the present disclosure. In some examples, the quantum dots 208 may be arranged in a random fashion where there is no exploitable symmetry in the array. This randomness in the array design may lead to better ML prediction. Further, the number of quantum dots 208 present in the array 202 may vary depending on the particular implementation. In general, the larger the array, the better or more accurate the results. However, it should be noted that beyond approximately 50 quantum dots, the devices are no longer able to be simulated on a classical computer.

Although a single source 204 and a single drain 206 are shown in this example, this need not be the case always. In other embodiments, the QMLD 200 may include a plurality of drain and/or source leads. Further, the number of gates utilized in the QMLD 200 may vary depending on the feature generating method used.

Further still, the quantum dot array 202 can be fabricated in 2D where the input gate electrodes G1-G8 are in-plane with the array 202 (as shown in FIG. 1B) and/or in 3D where the gates G1-G8 can be patterned on a second layer after overgrowing the quantum dot array layer with epitaxial silicon (as shown in FIG. 1A). The ultra-low gate density of Si:P quantum dots 208 allows for the fabrication of large quantum dot arrays with few control electrodes. In embodiments of the present disclosure, low gate densities of 1 gate for 100 s of quantum dots is possible. However, more gates for manipulating the array may be required. As such, in some embodiments there may be approximately 10 gates for controlling approximately 75 quantum dots. However, this is not critical and this ratio can be altered for different implementations without departing from the scope of the present disclosure.

The quantum dot array 202 is weakly coupled to the source 204 and drain 206 to measure the electron transport through the quantum dot array 202. Further, the quantum dot array 202 is capacitively coupled to the plurality of control gates G1-G8. The control gates 208 can be used to tune the electron filling, inter-dot couplings, and the single-particle energy levels of the quantum dot array 202.

The Hamiltonian (i.e., the underlying mathematical description) that describes the behaviour of electrons in the quantum dot array 202 is the 2D extended Hubbard model with long-range electron-electron interactions (V), on-site Coulomb interactions (U) and nearest neighbour electron transport (t). The Hamiltonian describing the system is:

$$H = {\sum }_{i = 1} {ϵ}_{i} {n}_{i} + {\sum }_{i} {U}_{i} {n}_{i} ( {n}_{i} - 1 ) + {\sum }_{i} {t}_{i , i + 1} ( {c}_{i}^{†} {c}_{i + 1} + h . c . ) + {\sum }_{i , j} {V}_{i , j} {n}_{i} {n}_{j} \qquad ( 2 )$$

Where, the electron hopping term (t) is related to the tunnelling probability of an electron between nearest neighbour donor sites. The intra-site Coulomb interactions (U) is the energy required to add a second electron to a site. The inter-site Coulomb interaction (V) is the energy required to add an electron to a neighbouring site—this may include interactions over all pairs of sites i and j. Parameters U, V and t are fixed by the configuration and the distance between the dots. Lastly, ϵᵢ is the single-particle energy level for the i^{th} site.

The Hubbard model ground state problem has been shown to be Quantum Merlin Arthur (QMA) complete (a complexity type in computational complexity theory), implying that the ability to control the ground state of the Hubbard Hamiltonian offers the potential for a large computational resource. The techniques described in the following sections leverage this computational power of the Hubbard model for machine learning in a way that is agnostic to the downstream task.

### Generating Features for ML

The QMLD 200 may be used to generate features for a ML model. For example, classical input data \vec{xᵢ} can be transformed into voltages to be applied on one or more of the gate electrodes. In some examples different voltages may be applied to each gate. In other examples, the same voltages may be applied to two or more of the gate electrodes. What voltages are applied to the gate electrodes may ultimately be dependent on the particular ML algorithm used. The applied voltages are used to change the Hubbard parameter (ϵᵢ) for ML. A source voltage may then be swept to measure a current curve at the one or more drain leads 206 of the QMLD 200. This measured current curve can then be analysed to find the charge excitation gap (CEG) or the current at a particular source voltage. The CEG, current or conductance is then used to output a non-linear function mapping that can be used by classical ML models.

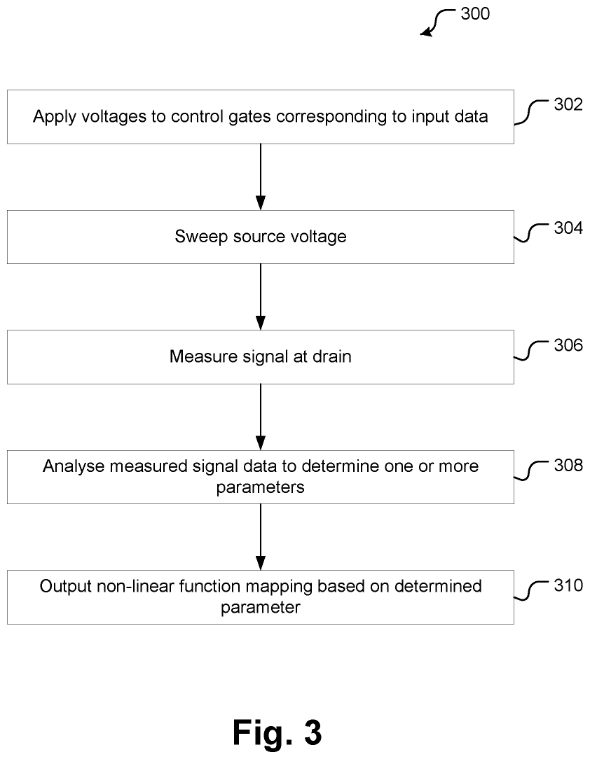

FIG. 3 is a flowchart illustrating an example method 300 for generating features for quantum ML according to aspects of the present disclosure.

The method 300 commences at step 302, where input data is applied to one or more of the control gates (e.g., one or more of control gates G1-G8). In some example, raw input data is applied as voltages to the control gates. In other examples, the input data is transformed before being applied as voltages to the control gates. In some embodiments, the input data is represented as a vector. For example, if the input data is an image of a cat, then the input data vector may be a colour scale of each pixel in the image. This input data vector is then converted into voltages and used as input to the ML model.

Next, at step 304, a constant voltage or a voltage sweep is applied to the source lead 202. The sweeped voltage may range in a few millivolts. A direct current (DC) or radio frequency (RF) sweep may be used. In an RF sweep, each drain lead 206 is connected to a resonator circuit (not shown) with a different frequency. The use of RF also allows for multiplexed measurement of several drain leads 206 for parallelised operation for further reducing the processing time for machine learning methods. This multiplexing can be achieved with an RF sweep as each drain lead 206 is connected to a resonator with a different frequency. In this way, a voltage sweep with different frequencies can be applied corresponding to the various drain leads.

Next, at step 306, current is measured at the drain leads 206 as a function of the source voltage. The measured current data may be plotted against the source voltage to yield a current curve. FIG. 2B shows examples of these current curves measured at independent drain leads 206. In particular, FIG. 2B shows three plots 220, 222, 224, each with source voltage on the x-axis and current on the y-axis. Plot 220 shows the measured current as a function of the source voltage for a first data point x₁ applied as voltages to the gates 208. Plot 222 shows the measured current as a function of the source voltage for a second data point x₂ applied as voltages to the control gates 208. Lastly, plot 224 shows the measured current as a function of the source voltage for a third data point x₃ applied as voltages to the control gates 208.

At step 308 the current data obtained at step 306 is analysed to determine one or more parameters. In some examples, the parameter may be the charge excitation gap (CEG) and the measured current curve can be analysed to find the CEG. The CEG is the energy of the gap corresponding to the amount of energy needed to add an electron to the quantum dot array. The CEG is determined by finding the point where the current quickly rises. Then the voltage that causes the current to increase most rapidly is taken to be the CEG. In another example, the measured current curve may be analysed to determine the current at a particular source voltage. In another example, the parameter determined from the measured current curve is the conductance.

Next, at step 310 the values of the one or more parameters are interpreted as non-linear mappings of the input data to be used for the machine learning model. For example, if the parameter is CEG and quantum random kitchen sinks is used, the one or more values of the CEG are interpreted to be the features in an enhanced space ready for use in a ML model. Alternatively, if quantum kernel learning machine is used, interpreting the values of the one or more parameters may include determining a distance metric or similarity score between the values of the one or more parameters.

Importantly, these different features can be generated from a single voltage sweep of the source voltage at a particular set of input voltages on the gates. Alternatively, the current and conductance can be generated by taking a single current measurement, greatly reducing the processing time of the QMLD 200. These quantum enhanced features are predicted to be able to outperform classical features by virtue of their increased computational complexity over the classical counterpart.

Depending on the ML technique used for generating features, method 300 may be adapted. For example, although method 300 is described such that the voltages corresponding to the input data are applied to the control gates, this need not be the case in all embodiments. Instead, in some other embodiments, the voltages corresponding to the input data may be applied to one or more source gates and/or to one or more drain gates either in addition to the control gates or instead of the control gates.

Further, depending on the method used, the way the data is applied as voltages and the way the output is interpreted may vary. Some example methods and variations will be described in the following sections. For example, when using the Quantum Random Kitchen Sink (QRKS) method, input voltages are a random transform of the input data, and the output parameters are added feature dimensions. In another example, using the Quantum Extreme Learning Machine (QELM), input voltages map directly to the input data and output parameters are interpreted as added feature dimensions. In yet another example, using the Quantum Kernel Learning Machine (QKLM) method, input data is applied as voltages in pairs. For example, data point xᵢ and data point x₂ are combined and applied as voltages to the gates 208. The output parameter is then interpreted as a distance metric or similarity score between them.

Further still, although in step 306, a current signal is measured at the drain leads 206 as a function of the source voltage, this need not be the case in all embodiments. In some embodiments, other types of signals, e.g., voltage, capacitance, conductance, inductance, etc., can be measured together with or instead of the current signal. The measured signal data may then be plotted against the source voltage to yield a signal curve.

FIGS. 2C and 2D show examples of these other signal curves measured at independent drain leads 206. In particular, FIG. 2C shows the setup for measuring RF-transmission of the QMLD by applying an oscillating voltage (V_{RF}) to the source 204 with a bias tee (not shown). The drain 206 is connected to an LC resonator circuit (L) and parasitic capacitance, which converts the output current signal into a voltage signal. This voltage signal is then amplified and demodulated with the original V_{RF} signal to obtain the amplitude and phase change of the voltage signal travelling through the array. FIG. 2D shows three plots 230, 232, 234, each with source voltage on the x-axis and another signal on the y-axis (e.g., voltage output). Plot 230 shows the measured voltage amplitude or phase as a function of the source voltage for a first data point x₁ applied as voltages to the gates 208. Plot 232 shows the measured voltage amplitude or phase as a function of the source voltage for a second data point x₂ applied as voltages to the control gates 208. Lastly, plot 234 shows the measured voltage amplitude or phase as a function of the source voltage for a third data point x₃ applied as voltages to the control gates 208. The amplitude and phase of the voltage signal can then be used similar to the current signal to perform machine learning.

While the QMLD 200 has been described using donor based quantum dots, it will be appreciated that the QMLD system 200 and ML method can also work with gate defined quantum dots.

The following sections describe a number of different quantum ML techniques that can be performed using the QMLD 200 described herein.

### Quantum Extreme Learning Machine (QELM)

In classical machine learning literature, an Extreme Learning Machine is a form of feed-forward neural network architecture where the parameters and structure of the network are fixed and randomised, implementing a nonlinear projection. A simple model, for example linear regression, is then trained on this projected feature space. Extreme Learning Machines have been shown to be universally approximating under very loose conditions, and have been shown to outperform various other techniques including support vector machines.

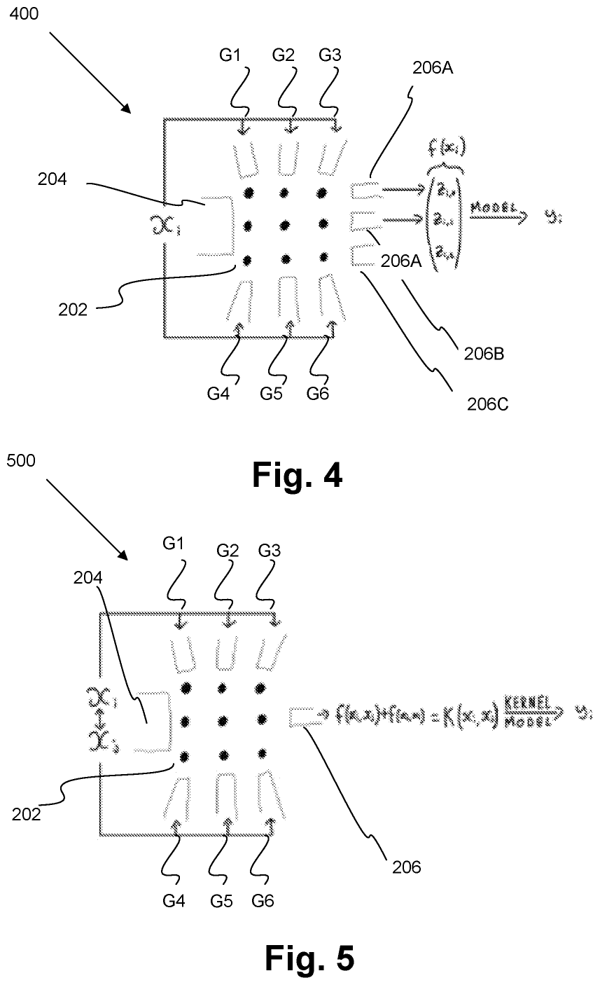

FIG. 4 shows a schematic diagram 400 of a hardware based QELM process according to aspects of the present invention. The QELM process utilizes the QMLD 200 and includes a quantum dot array 202, a single source lead 204, one or more drain leads 206, and one or more gates G1-G6. Each drain lead 206 may correspond to a dimension feature. This example figure shows a 3×3 array of quantum dots, three drain leads 206A, 206B, 206C, and six control gates G1-G6 and can generate three data dimensions. If more dimensions are required, the number of drain leads 206 can be increased.

For each input data point xᵢ, a nonlinear projection is achieved by mapping each input dimension to a control gate and applying a voltage to the control gates G1-G6. The input data points are transformed into voltages and then used to generate additional features. Measurements of the output current are then taken at the drain leads 206 and are used as an enhanced feature space f(xᵢ). The dimension of the resulting feature map is equal to the number of drain leads 206, which could experimentally limit the power of this method. The enhanced feature space obtained from this technique may then be used in a downstream ML task. For example, the dataset f(xᵢ) may be used in a ML model to classify or predict some property yᵢ about the input. In the QELM process every training and testing data point is required to be transformed. Therefore, the number of measurements is a product of the measurements per transform and the number of data points.

### Quantum Kernel Learning Machine (QKLM)

Another method for generating features is to use the QMLD 200 as a Quantum Kernel Learning Machine.

FIG. 5 shows a schematic diagram 500 of a QKLM process according to aspects of the present disclosure. The QKLM process utilizes the QMLD 200 having a quantum dot array 202, a single source lead 204, a single drain lead 206, and a plurality of control gates G1-G6. In the QKLM method the number of control gates limits the size of the data. This is different to the QELM method described above where the data is mapped onto different gate voltages. In the QKLM method for d dimensional data, it is likely that 2d control gates would be used so that two data points can be mapped simultaneously.

The kernel trick is a technique used in ML whereby the dot product between vectors is replaced by a kernel function. Mercer's theorem states that if the kernel function is symmetric, continuous, and its evaluation between all pairs of data points forms a positive semi-definite matrix, then it can be represented as an inner product in a transformed space (the feature space): K(xᵢ, xⱼ)= [symbol] ϕ(xᵢ), ϕ(xⱼ) [symbol] for some transformation ϕ. This means that similarity measurements can be calculated in high dimensional, complex vector spaces without calculating the vector representations in those spaces, which can be more efficient or give access to otherwise impossible transformations. For example, a common kernel used in support vector machines (SVMs) is the radial basis function kernel: RBF(x₁, x₂)=exp (−γ∥x₁−x₂∥²). The feature space representation of this kernel is infinite dimensional.

The QKLM process commences with two data points xᵢ and xⱼ being applied to the control gates 208 symmetrically. Here, symmetrically means that for f(xᵢ, xⱼ)=f(xⱼ, xᵢ) i.e., if the order of the inputs is swapped then the result does not change. In one example this may be achieved by applying data point 1 (xᵢ) to the top control gates (G1-G3) and data point 2 (xⱼ) to the bottom control gates (G4-G6), then applying data point 2 (xⱼ) to the top control gates (G1-G3) and data point 1 (xᵢ) to the bottom control gates (G4-G6) and summing the outputs. This would ensure that if data points 1 and 2 (xᵢ and xⱼ) were swapped, the result would not change. This ensures a proper distance metric is maintained. For example, both questions: “what's the distance from Melbourne to Sydney” and “what's the distance from Sydney to Melbourne,” would yield the same output.

A kernel function may then be defined based on the resultant measurements of the current at the drain lead 206 that satisfies the criteria of a kernel and this kernel is used in a ML model. As described previously, this technique requires two control gates 208 per data dimension and a single drain lead 206. Using the QKLM process, the kernel is calculated between every pair of training data points and between every testing data point and training data point. Thus, for the QKLM process the number of measurements can be given by:

$$measurements per kernel calculation \times ( \# training {datapoints}^{2} + ( \# training datapoints \times \# testing datapoints ) )$$

### Quantum Random Kitchen Sinks (QRKS)

Random kitchen sinks is a technique in which the feature space is generated by randomly transforming the input data points. It will be appreciated that this method can approximate functions under certain conditions. For example, this method can approximate a cost function such as a L-Lipschitz function whose weights decay more rapidly than the given sampling distribution when the maximum size of any projected point is less than or equal to 1. QRKS has been shown empirically to perform competitively with other techniques under such conditions.

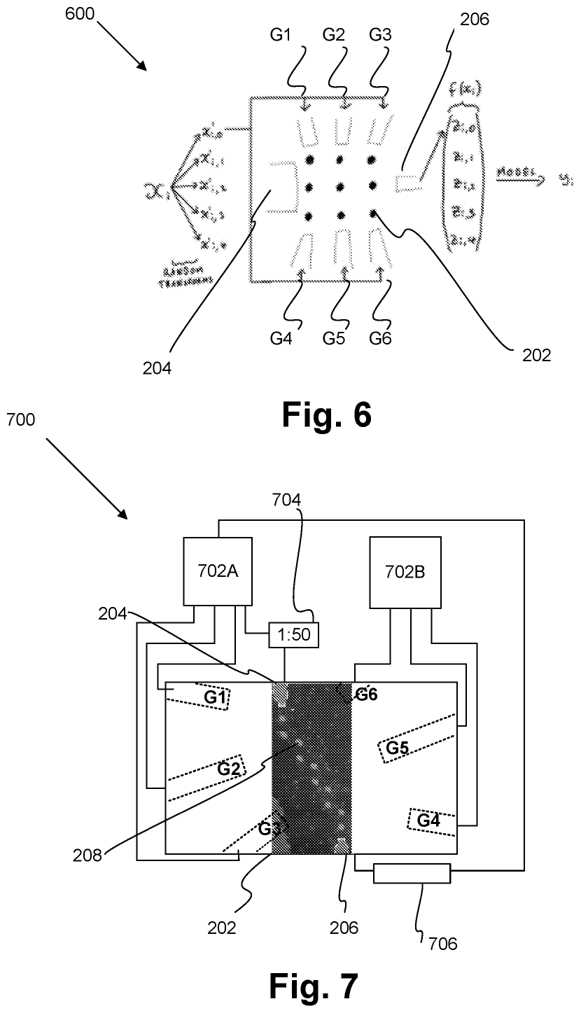

FIG. 6 shows a schematic diagram 600 of a QRKS process according to aspects of the present disclosure. The QRKS process can also be performed on the QMLD 200 described above. In this example, the QMLD 200 includes a quantum dot array 202, a single source lead 204, a single drain lead 206, and plurality of control gates (six gates in this example, G1-G6) for each data dimension of the randomly linearised input data. The number of control gates may allow for better accessibility or change of the Hamiltonian, possibly leading to higher-dimensional output. However, the QRKS process can be used with arbitrary number of gates.

Like QELM, Quantum Random Kitchen Sinks (QRKS) implement random nonlinear projections into a new feature space, however unlike QELM the number of dimensions of the feature space can be arbitrarily sized. That is, the dimension is not limited by the number of drain leads.

For each desired feature dimension, a random linear transformation is applied to every data point in the dataset: \vec{xᵢ′}=w\vec{xᵢ}+\vec{b}. Where w is an n×m matrix with elements that are sampled from a Gaussian distribution, n is the dimensionality of the data, and m is the number of control gates 208. And \vec{b} is a vector of the same length as the number of input gates 208 with elements that are sampled from the uniform distribution. This transformed dataset is applied directly to the input gates 208. The currents are measured at the drain lead 206 and are used as an enhanced feature space f(xᵢ). This is repeated for each desired feature dimension to achieve the desired dimensionality to be used in a downstream ML process.

As shown in FIG. 6, a data point xᵢ is randomly transformed multiple times. Each random transformation corresponds to a new feature dimension, and each feature dimension has the same linear transformation for all data points. For each new feature of each data point, the transformed data is applied as gate voltages to the control gates G1-G6 and the output current is measured by the drain lead 206. Each transformation and measurement adds one dimension to the enhanced feature space representation of that data point.

Note that while randomly sampled, corresponding transformations must be the same across different data points. The size of the enhanced feature space is arbitrary in this model as more transformations can be sampled. In addition to this, if multiple drain leads are used, multiple dimensions can be appended to the enhanced feature space with each measurement. In this model, every training and testing point must be transformed, meaning that the number of measurements is given by:

$$measurements per transform \times \# datapoints \times \# feature dimensions$$

As described previously, the different ML algorithms (QELM, QKLM, and QRKS) have slightly different QMLD 200 requirements. These source, drain and control gate requirements are summarised in Table A below.

TABLE A
Device requirements for different feature generating methods.

| | Source Gates | Drain | Control gates, | Measure- |
|---|---|---|---|---|
| Method | (nₛ) | Gates, (n_{d}) | (n_{c}) | ments |
| QRKS | ≥1 | ≥1 | ≥1 | nₓd_{f}/n_{d} |
| QELM | 1 | d_{f} | d_{d} | nₓ |
| QKLM | 1 | 1 | 2d_{d} | ${n}_{x}^{2}$ |

Where, the parameters in Table A are defined as: nₛ: Number of source gates, n_{d}: Number of drain gates, n_{c}: Number of control gates, d_{f}: Feature dimension, d_{d}: Input data dimension, and nₓ: Number of data points.

### Results—I

In a first set of experiments, the performance of QRKS was evaluated using a 10 quantum dot device and compared to classical random kitchen sinks for 3 data sets: hyperspheres, ad-hoc dataset, and polynomial separation.

FIG. 7 shows a STM lithography of a QMLD 700 used to evaluate the performance of the QRKS. In this device there are 10 donor based quantum dots 208 in the quantum dot array 202, a source 204, a drain 206 and 6 control gates G1-G6. The 10 donor quantum dots 208 are phosphorus quantum dots embedded in a silicon substrate. Two data acquisition units 702A, 702B were used to measure the device 700, with 1:50 voltage divider 704 and a current amplifier 706 used to amplify the signal.

### Ad-Hoc Dataset

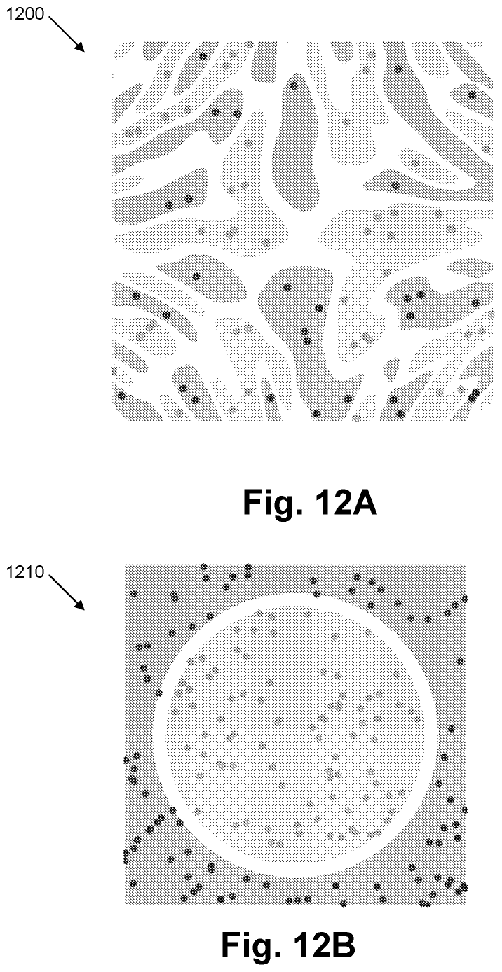

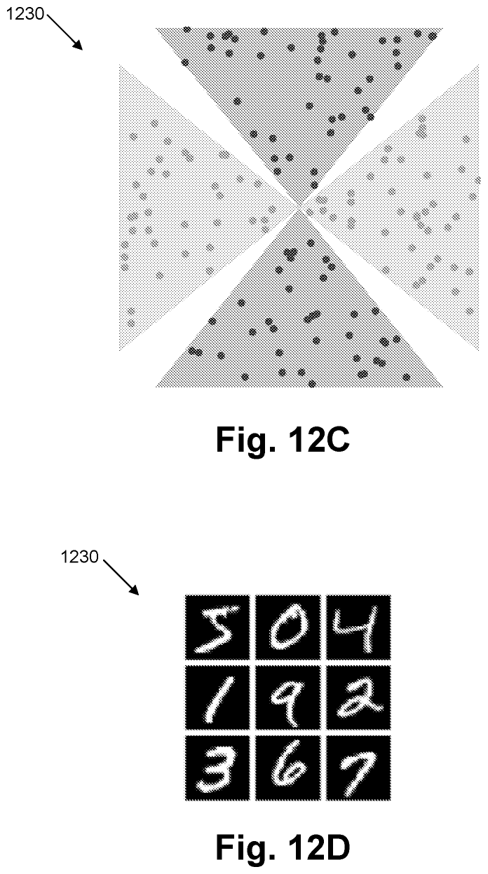

The Ad Hoc dataset (schematically depicted in FIG. 12A) classifies points using a quantum circuit that is conjectured to be hard to simulate classically. It is based on a low-depth quantum circuit and was designed to be perfectly separable via a variational quantum method. The dimension of this dataset corresponds to adding qubits to the quantum circuit. The coordinates of each datapoint in this dataset essentially parameterises a quantum circuit.

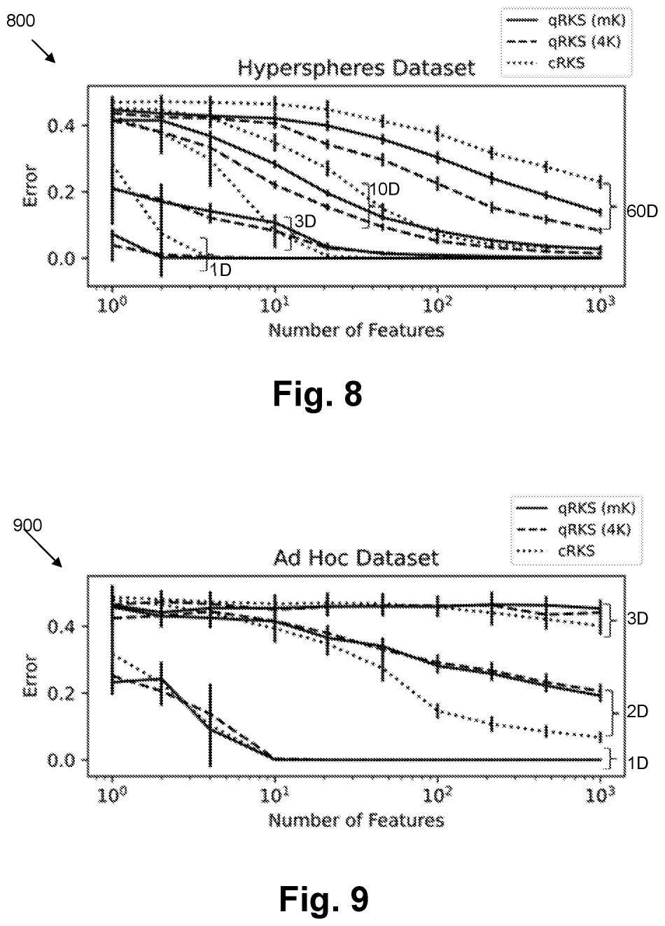

FIG. 8 shows a plot 800 of the performance of QRKS at 4K and at mK measurements at completing an ad-hoc classification task compared to classical random kitchen sinks. In particular, the plot shows the performance of the QRKS and classical random kitchen sinks at completing this task for different data dimensions—1D, 2D and 3D.

The x-axis of the plot 800 indicates the number of features generated and the y-axis indicates the classification error. The models were trained on approximately 1000 datapoints and tested on approximately 270.

The performance of the QRKS at 4K and mK measurements is about the same for all three dimensions. However, the performance of the cRKS improves in comparison to the QRKS as the number of features generates by the models increases for the two dimensional dataset.

On this dataset, as seen from plot 800, the features generated using the quantum functions perform similar to the classical features for 1D and 3D data.

### Hyperspheres

The hyperspheres datasets are n-dimensional versions of the circle dataset commonly used for simple ML models. FIG. 12B shows a schematic of a hyperspheres dataset.

Given an n-dimensional coordinate x∈[−1,1]ⁿ, it is considered “inside” the hypersphere if x²≤r, where r is the radius of the hypersphere, and “outside” otherwise. The task of the model is to classify points into either “inside” or “outside.” Since a linear support-vector machine (SVM) can only separate points via a hyperplane, it can only be expected to achieve a maximum of 50% accuracy on this task.

FIG. 9 shows a plot 900 of the performance of QRKS at 4K and at mK measurements at completing this classification task compared to classical random kitchen sinks. In particular, the plot shows the performance of the QRKS and classical random kitchen sinks at completing this task for different data dimensions—1D, 3D, 10D and 60D. On the x-axis is the number of features generated and on the y-axis is the classification error.

On this dataset, as seen from plot 900, the features generated using the quantum functions significantly outperform classical features at least for the 60D data. In particular, as the number of features increases, the classification error reduces. The quantum methods achieve approximately a 20% error rate while the classical features have an error rate between 30%-40% for 60D. For lower dimensions, both CRKS and QRKS perform similarly as the number of features increase, but the QRKS outperforms the CRKS for lower number of features.

### Polynomial Root Separation Dataset

The polynomial separation dataset (as seen in FIG. 12C) consists of the coefficients of univariate polynomial of order n−1. The minimum separation between two roots of each polynomial is calculated and any values greater than a threshold are marked. A larger dimensional sample space corresponds to higher order polynomials. In 2D, the coordinates are (x,y). A polynomial is defined using these coordinates, e.g., (xa+y), where the variable in this case is a. The roots of this polynomial (xa+y=0) are used to define the dataset. In 3D, the coordinates are (x, y, z) and a polynomial can be defined as (xa²+ya+z=0), in 4D, the coordinates may be (x1, x2, x3, x4) and the polynomial may be (x1a³+x2a²+x3a+x4=0). The order of the polynomial is the maximum power of a, which is d−1 where d is the number of dimensions.

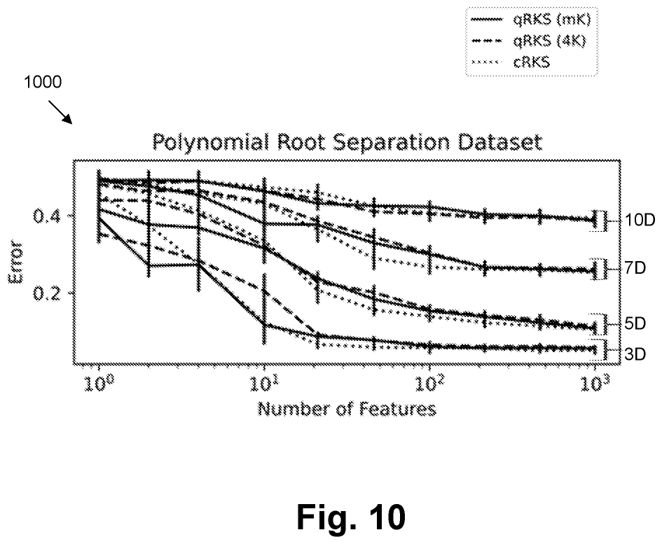

FIG. 10 shows a plot 900 of the performance of quantum RKS at 4K and mK measurements compared to classical RKS. In particular, the plot shows the performance of the QRKS and classical random kitchen sinks at completing this task for different data dimensions—3D, 5D, 7D, and 10D. On the x-axis is the number of features generated and on the y-axis is the model error.

The quantum features again perform just as well as the classical features at 4K and the mK measurements for all data dimensions.

### Results—II

In a second experiment, the performance of QRKS was evaluated using a different quantum dot device and compared to classical random kitchen sinks for different datasets.

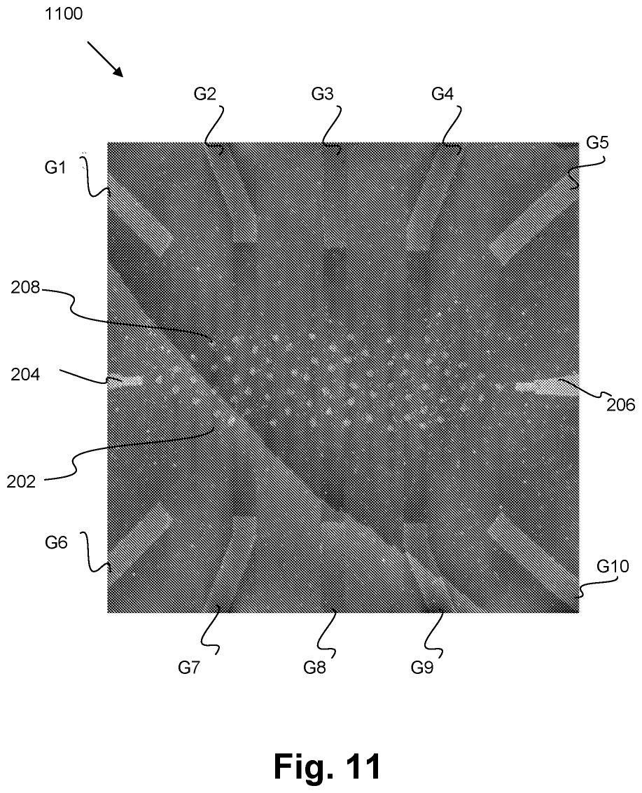

FIG. 11 shows a STM micrograph of the QMLD 1100 used in the second experiment to evaluate the performance of the QRKS. This device 1100 includes 75 donor based quantum dots 208 in the quantum dot array 202, a source 204, a drain 206, and ten control gates G1-G10. The 75 donor quantum dots 208 are phosphorus quantum dots embedded in a silicon substrate.

As previously mentioned, the Hubbard parameters U, V and t are fixed by the configuration and distance between the dots 208 in the quantum dot array 202. The QMLD 1100 is designed to randomise these parameters (U, V, and T), thereby providing richer dynamics for the reservoir. This was achieved by constructing the quantum dot array 202 on a triangular lattice. In order to introduce some randomness to make the device potentially more effective, the locations were then randomly jittered in the x and/or y coordinates so that they each slightly move in a random direction by a random amount. This results in the final array seen in FIG. 11.

Voltages applied to the control gates G1-G10 reconfigure the on-site energy levels ϵᵢ of the sites, and the resultant charge transport through the quantum dot array 202 is measured as a current via the source 204 and drain 206 leads. This current is a function of the quantum state of the quantum dot array 202, which due to the large coupling strength of adjacent quantum dots and the low measurement temperature (approximately 30 mK) is in the strong quantum regime—where quantum effects dominate. The parameter range where this is applicable is when the thermal energy is small compared to all the other energy scales in the system.

In this example QMLD 1100, the dimension of xₑ′ is chosen to be n=10 to correspond to the number of control gates G1-G10 in the device. Each element x_{e,i}′ is directly applied as a voltage to gate Gi, and measuring the current that flows through the device returns the result of the nonlinear transform.

Each matrix w is generated by sampling each matrix element randomly from a Gaussian distribution with mean μ=0 and standard deviation σ, and each b was generated by sampling each vector element IID from a uniform distribution with interval [w, b]. Varying σ changes the volume of gate space that the algorithm has access to, resulting in features with differing complexity.

To prevent the breakdown of the silicon substrate 102 at high voltages, resulting in leakage current between the gates, the voltage applied to any gate must fall within a maximum range of [−0.5V, 0.5 V]. The voltages produced in [0110] are calculated and any features that have a range greater than an allowed voltage range have the corresponding row of the transformation matrix resampled until either the range is small enough or some threshold of attempts is reached. The range for the uniform offset is then defined by the range of the voltages in each feature. The source-drain bias is set to 4 mV for all experiments.

### Datasets

The QMLD 1100 was tested using three synthetic data sets: Hyperspheres (shown in FIG. 12B), Polynomial Separation (shown in FIG. 12C), and Ad Hoc (shown in FIG. 12A). FIG. 12A-12C show visualisations of the synthetic datasets. Each dataset consists of points separated into two classes-depicted by different colours. The job of the QRKS is to learn how to separate points into the two classes given only the coordinates of each point.

Further, in each plot, the light grey and dark grey regions represent the regions in which points of each class reside. Any point in a dark region is classified as dark and any point in a light grey region is classified as light. The white regions are areas where no points are sampled from. The light and dark grey points in these example schematics are example points that are plotted and classified into the corresponding color of the region they are in.

The ad-hoc dataset (shown in FIG. 12A) is based on a low-depth quantum circuit and was designed to be perfectly separable via a variational quantum method. The dimension of this dataset corresponds to adding qubits to the quantum circuit. The coordinates of each datapoint essentially parameterise a quantum circuit. The result of the quantum circuit is used to classify the datapoint, using a higher dimensional datapoint (corresponding to more values in its vector), is equivalent to running a similar circuit but with more qubits contained in it.

The Hyperspheres dataset (as seen in FIG. 12B) consists of randomly sampled points in an m dimensional unit hypercube. Points that lie inside the hypersphere are then marked, and the models must identify which points are marked. The different color dots in FIG. 12B represent different classification classes—i.e., dots that are classified as lying inside the hypersphere are one color and the dots that are classified as lying outside the hypersphere are another color.

The polynomial separation dataset (as seen in FIG. 12C) consists of the coefficients of univariate polynomial of order n−1. The minimum separation between two roots of each polynomial is calculated and any values greater than a threshold are marked. A larger dimensional sample space corresponds to higher order polynomials. In 2D, the coordinates are (x,y). A polynomial is defined using these coordinates, e.g., (xa+y), where the variable in this case is a. The roots of this polynomial (xa+y=0) are used to define the dataset. In 3D, the coordinates are (x, y, z) and a polynomial can be defined as (xa²+ya+z=0), in 4D, the coordinates may be (x1, x2, x3, x4) and the polynomial may be (x1a³+x2a²+x3a+x4=0). The order of the polynomial is the maximum power of a, which is d−1 where d is the number of dimensions.

For these three datasets, an output threshold is chosen such that 50% of the input data points are marked, and points sufficiently close to this threshold are discarded to ensure class separation.

These three synthetic datasets were chosen to present differing levels of difficulty to test the QRKS model. Hyperspheres is considered an easy dataset due to the simplicity of the separating boundary, whereas polynomial separation and ad-hoc datasets have more complex separating boundaries. In particular, the ad hoc dataset is conjectured to be difficult to compute classically, implying that an ad-hoc dataset based on a large number of qubits will appear completely random to a classical computer.

In addition to selecting datasets of varying degrees of difficulty, each dataset was tested in a variety of dimensions. The effect of this is two-fold. Firstly, the sampling density of points exponentially decreases with the number of dimensions, making the datasets hard due to a relative lack of data points. Secondly, in the case of polynomial separation and ad-hoc, the computational complexity of the function defining the separating boundary increases.

Since all the synthetic data points are based on randomly sampled points, the same measurements can be reused to evaluate the model performance on all three by simply selecting different subsets of the data and redefining the class assignment of each point. A total of 3000 points were measured and after discarding points close to the separating boundary, approximately 2700, 2400, and 1850 were obtained for the hypersphere, polynomial separation, and ad hoc datasets, respectively. There were some small variations in the number of points in different dimensions. For each dataset, 70% of the points were used as a training set and the remaining 30% were used as a testing set.

The QMLD 1100 was also tested using a real dataset-Modified National Institute of Standards and technology dataset (MNIST dataset). MNIST is a dataset consisting of 28×28 pixel images of 70,000 handwritten digits (60,000 training examples and 10,000 testing examples) and is a standard benchmark dataset in the field of ML. FIG. 12D illustrates a few examples of these images.

In this experiment, the models are trained on both the full dataset and a subset of MNIST including only the digits 3 and 5—these are two digits that a linear classifier finds hardest to separate. There are 11,551 training examples and 1903 testing examples in this subset. For the purpose of this experiment, the dimension of the MNIST input data was reduced from 784 to 10 dimensions using a principal component analysis (PCA) decomposition.

### Models

The QRKS model on QMLD 1100 was compared to three models: linear support vector machine (LSVM), a SVM with radial basis function (RBF) kernel, and the classical version of the random kitchen sinks methods with cosine linearity (CRKS).

A LSVM was used to classify the features generated by the QMLD 1100. Note that the random kitchen sinks process introduces no linearity except that of the quantum mapping, meaning any performance gain over an LSVM by itself stems directly from the device 1100 and is not a side effect of pre- or post-processing.

Each model has a scale parameter “gamma” and a regularisation parameter “C”, where the optimum values of each depends on both the model and the dataset. The scale parameters, for CRKS and QRKS represent the width of the Gaussian distribution that the transformation matrix w is sampled from, and the scale parameter for the RBF SVM defines the region of influence of each support vector. The regularisation parameter defines how much each model is penalised for extreme values in the weights matrix. In other words, regularisation is a method for preventing overfitting, which is when a machine learning model memorises the data in a dataset instead of learning the general trends and patterns that allow it to generalise to unseen data. Models that have been overfit tend to perform very poorly when used to classify datapoints outside of their training set. If the parameters that the model learns are extremely large this can indicate that the model is being overfit. Regularisation introduces a cost to having large model parameters that mitigates this phenomenon.

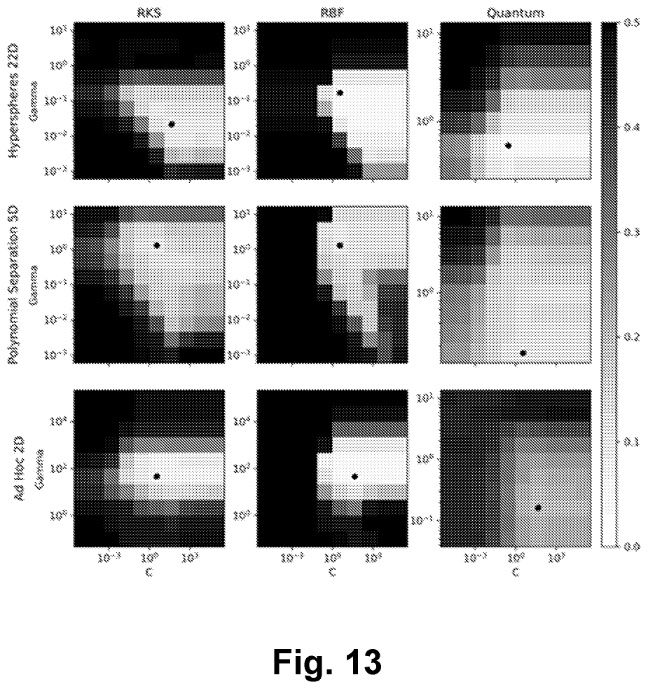

FIG. 13 is a grid of nine subplots showing the performance of each model—RKS (left three subplots), RBF (middle three subplots), and QRKS (right three subplots)—on each dataset (hyperspheres top three subplots, polynomial separation middle three subplots, and ad-hoc bottom three subplots) as a function of the hyper-parameters used to perform the optimization. The color gradient represents the accuracy of the model, with black being highest error rate (0.5) and white being the lowest error rate (0). The axes of each subplot represent the value of the hyper-parameters C (x-axis) and gamma (y-axis). The spot on each tile represents the optimum hyper-parameters for each model for each dataset.

### Training and Testing Procedure

Each dataset was rescaled to the range [−1, 1] prior to training, and the output features of the QMLD 1100 were also scaled back into this range prior to being fed into the LSVM. The scale and regularisation hyper-parameters were optimised for each dataset via a grid search: each model was trained on a subset of 500 data points for each combination of hyper-parameter values and tested on a validation set. The best values that led to the best performing models were then used when training on the entire dataset.

A total of 1000 features were generated for CRKS and QRKS for each of the synthetic datasets, and 10,000 features were generated for the MNIST dataset.

In order to build statistics of model performance, 300 random train/test splits were generated and a randomly initialised model was trained and tested on each of those splits. In other words, error bars are created by training many model with random initial conditions and collating their accuracies to get a more accurate estimate of the mean and standard deviation of the accuracy of the technique.

### Results

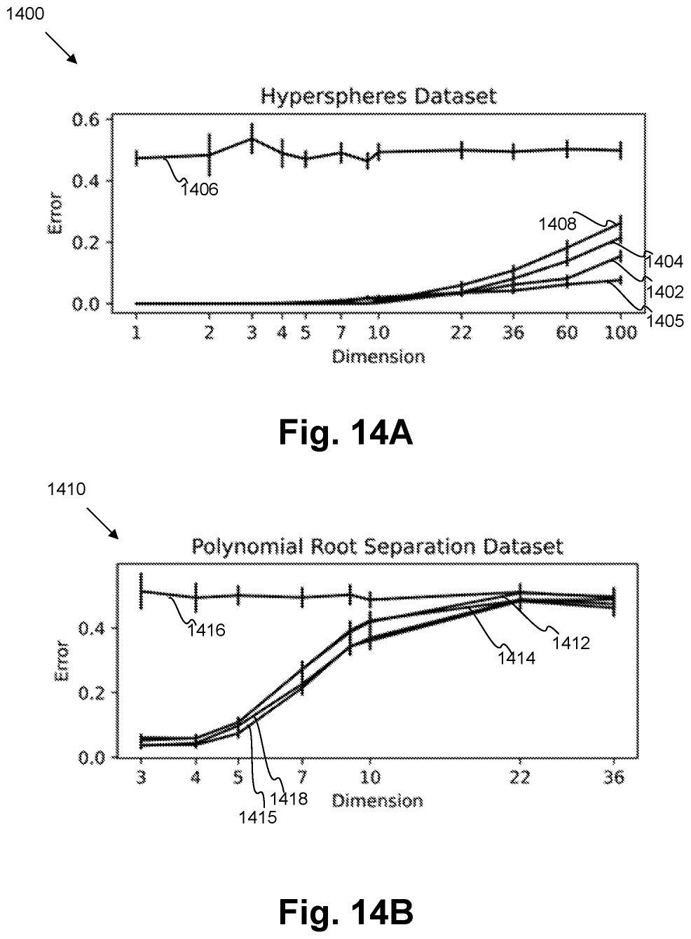

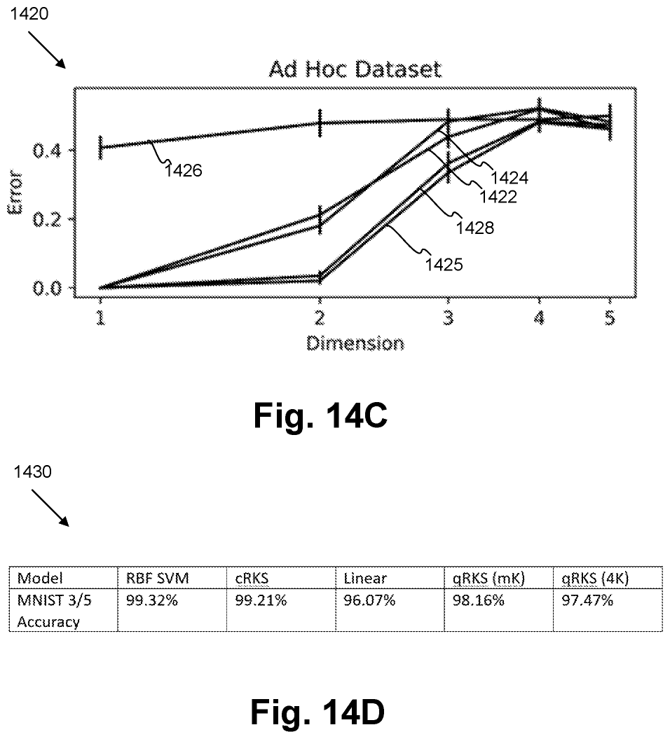

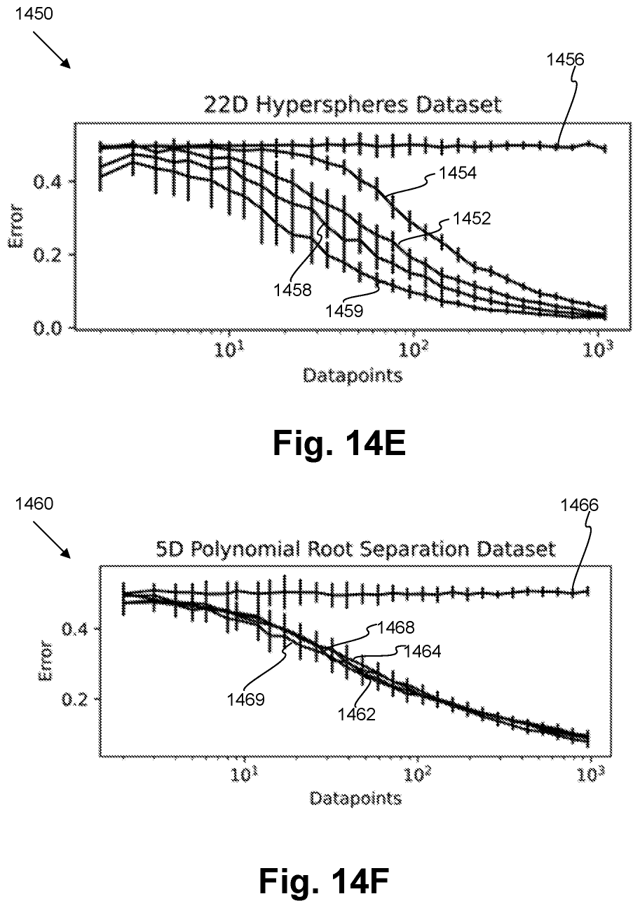

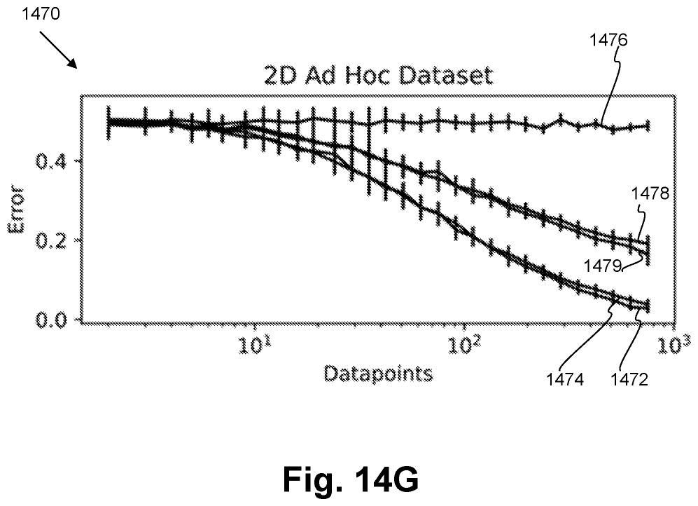

FIG. 14A is a plot 1400 of the performance of the QRKS model (at 4K 1402, and mK 1404) compared with the three classical models RBF SVM 1405, LSVM 1406 and CRKS 1408 on the polynomial separation dataset. On the x-axis is the dimension of the feature space generated and on the y-axis is the classification error.

FIG. 14B is a plot 1410 of the performance of the QRKS model (at 4K 1412 and mK 1404) compared with the three classical models RBF SVM 1415, LSVM 1416 and CRKS 1418 on the ad hoc dataset. On the x-axis is the dimension of the feature space generated and on the y-axis is the classification error.

FIG. 14C is a plot 1420 of the performance of the QRKS model (at 4K 1422 and mK 1424) compared with the three classical models RBF SVM 1425, LSVM 1426 and CRKS 1428 on the hyperspheres dataset. On the x-axis is the dimension of the feature space generated and on the y-axis is the classification error.

The QRKS consistently and significantly outperforms an LSVM on all datasets, showing that the nonlinear transform provided by the QMLD 1100 is both useful and general purpose. In addition to this, the QRKS performs competitively compared to the RBF SVM and CRKS methods, despite the technique being far less mature and implemented on noisy hardware. The inherent noise-robustness of the reservoir/random kitchen sink algorithm is apparent when comparing to the performance of the QRKS at 30 mK to the performance at 4 K. Despite the increase in measurement noise, the performance only decreases slightly.

The plots shown in FIGS. 14A-14C also exemplify the differing difficulty of each of the datasets. The hyperspheres dataset is easily separable by all models (except linear) until very large dimensions, while on ad hoc no models perform better than randomly guessing for any dimension greater than three. The model performances steadily decrease as a function of dimension for the polynomial separation dataset, making it a good dataset for judging a model's robustness to complexity. Whilst the QRKS is still outperformed by RBF SVM and CRKS, it does not converge to randomly guessing any faster, reinforcing that the technique is general purpose and able to learn complex separating boundaries.

FIG. 14D is table illustrating the performance of the QRKS model 1440 compared with the three classical models RBF SVM 1442, LSVM 1444 and CRKS 1446 on the 3-5 subset of the MNIST dataset.

FIG. 14E is a plot 1450 of the performance of each of the models as a function of the number of data points (x-axis) for a 22D hyperspheres dataset. In particular, plot 1456 is for the LSVM model, plot 1454 corresponds to the CRKS model, plot 1452 corresponds to the RBF model, plot 1458 corresponds to the mK QRKS model and 1459 corresponds to the 4K QRKS model. From FIG. 14E, it can be seen that no model is able to learn more effectively with fewer data points than any of the others. However, as the number of datapoints increase, the error rate (along y-axis) of the CRKS, RBF, and QRKS models decreases, while for the linear model remains the same.

FIG. 14F is a plot 1460 showing the performance of the each of the models as a function of the number of data point for a 5D polynomial root separation dataset. On the x-axis is the number of features generated and on the y-axis is the classification error.

In particular, plot 1466 is for the LSVM model, plot 1454 corresponds to the CRKS model, plot 1462 corresponds to the RBF model, plot 1468 corresponds to the mK QRKS model and 1469 corresponds to the 4K QRKS model. This plot, 14F, highlights that all the models expect the linear model perform relatively similarly for higher dimension polynomial root separation dataset.

FIG. 14G is a plot 1470 showing the performance of the each of the models as a function of the number of data point for a 2D ad-hoc dataset. On the x-axis is the number of features generated and on the y-axis is the classification error.

In particular, plot 1476 is for the LSVM model, plot 1474 corresponds to the CRKS model, plot 1472 corresponds to the RBF model, plot 1478 corresponds to the mK QRKS model and 1479 corresponds to the 4K QRKS model. This plot, 14G, highlights that the QRKS models perform better than the linear model, but not as well as the RBF and CRKS models for a 2D ad-hoc dataset.

### Another Variation

Another way in which the quantum ML device can be operated is as a reservoir. This operating regime takes advantage of the time dynamics of the device, with input signals being applied faster than the device is able to settle. For Random Kitchen Sinks, this would cause the outputs to depend on the order of the datapoints in the dataset, which is not desirable for the datasets such as hyperspheres, ad-hoc datasets, etc., described previously as each datapoint in these datasets is independent. However, for other types of datasets, e.g., time-series datasets, datapoints are not independent and can be ordered.

Random transformations are still used in this operating regime. In particular, a number of random transformations are generated and applied to the input data (e.g., time-series) which is then provided as a range of input voltages to the QMLD. The random transformations define the paths through voltage gate space. Where a path in voltage gate space is between a first and second voltage of the input voltages. Each random transformation results in a new feature being measured. These features are then measured and can be used in a machine learning model for prediction.

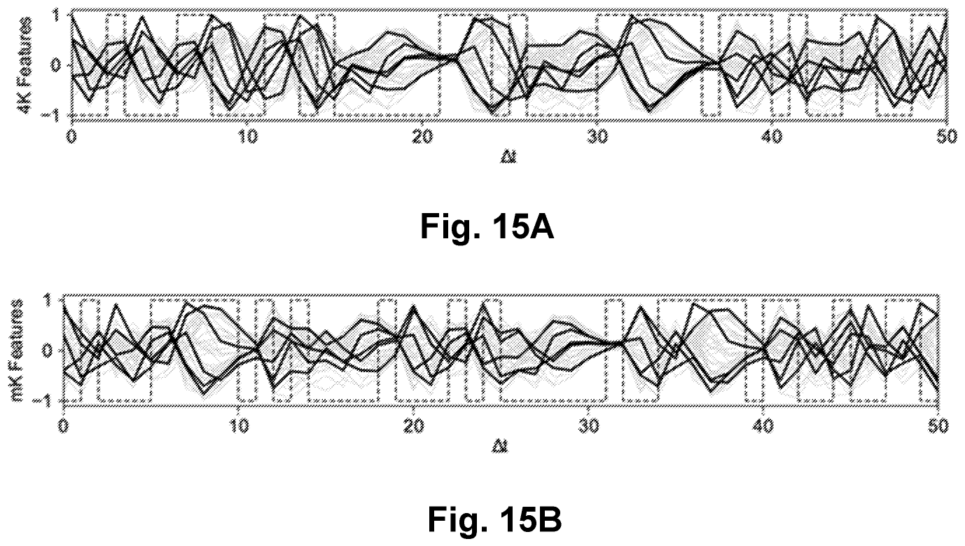

An example response of the QMLD 1100 operating as a reservoir to a random binary string input is provided in FIG. 15. In particular, FIG. 15A depicts the response at 4K and 15B depicts the response at approximately 30 mK. The input to the quantum ML device is depicted in FIGS. 15A and 15B with a dashed line and the generated features are shown in solid lines. Five random features have been highlighted in a darker color as examples of how individual features vary over time.

When the input signals are provided faster than the settling time of the QMLD, the history of the input signals is encoded in the instantaneous quantum state, meaning that a measurement at that time will encode information about both the present input and the past inputs. This ability to extract information about past inputs is called memory and the distance into the past that the QMLD is able to remember is called the “memory capacity.” In addition to this, the device is able to interact present inputs with previous inputs in a nonlinear way. The ability of the QMLD to perform complex non-linear transformations based on the points in its memory is called “nonlinear processing capacity” and the ability to perform linear transformations based on the points in its memory is called “linear processing capacity.”

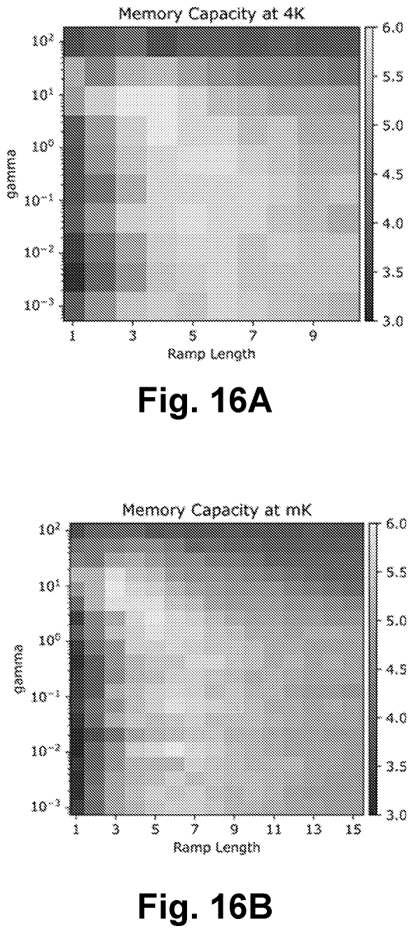

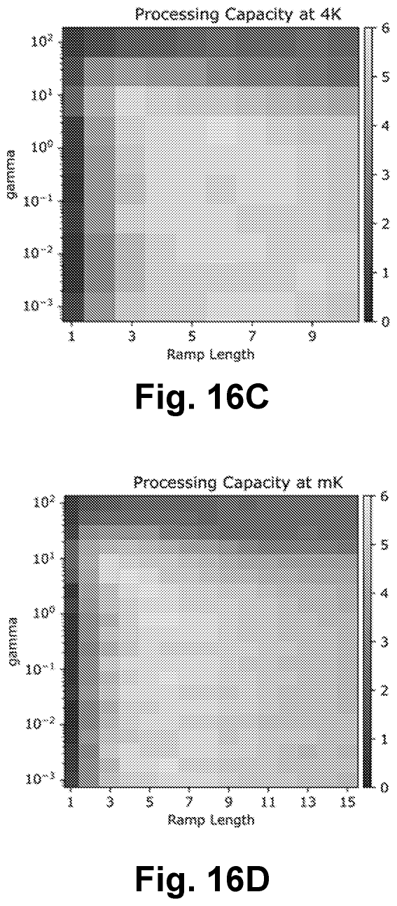

These two properties were measured using a binary input on the QMLD 1100. The results are depicted in FIGS. 16A-16D. For the memory capacity, the accuracy of correctly recalling the t−i^{th} input (where t is the current time step and i is swept from 1 to 10) is calculated and summed to give a metric. For the processing capacity, the accuracy of predicting the parity of the inputs from t−i to t is calculated and once again summed to give another metric. These metrics vary mainly with two hyper-parameters-Gamma and ramp length. Similarly to random kitchen sinks, a gamma variable controls the size of the random transforms, defining how much of voltage gate space the model has access to. The QMLD 1100 was measured with an input rate of 500 kHz, however the rate that datapoints are measured can be varied by changing how many of those points it takes to ramp between consecutive inputs along the path in the gate space. This variable is called ramp length.

FIGS. 16A-16D depict the memory capacity and processing capacity of the device at 4K and approximately 30 mK depending on both those hyper-parameters. In particular, FIGS. 16A and 16B depict the memory capacity at 4K and 30 mK, respectively. The scale represents the memory capacity or the number of data points from the past the device can remember. As shown in the figures, the memory capacity of the device can vary depending on the selected gamma and/or ramp length at both temperatures. Further, the maximum memory capacity for this device (i.e., QMLD 1100) is around 6 datapoints at 4K and 30 mK. It will be appreciated that the memory capacity of the device can be increased by increasing the time the device takes to settle.

FIGS. 16C and 16D depict processing capacity of the device at 4K and 30 mK, respectively. The scale represents the processing capability of the device based on the number of datapoints in its memory. In this example, the device was programmed to identify the number of Is in the datapoints in its memory. As can be seen from the figures, the processing capability of the device varies depending on the gamma and ramp length at both temperatures. Further, the device can perform processing on up to 6 datapoints from its memory.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

As used herein, except where the context requires otherwise, the term “comprise” and variations of the term, such as “comprising”, “comprises” and “comprised”, are not intended to exclude further additives, components, integers or steps.

1. A method for generating quantum features for a machine learning model, the method comprising:
providing a quantum ML device comprising one or more quantum dots, one or more source gates, one or more drain gates, and one or more control gates;
transforming input data for the machine learning model into first voltages;
applying the first voltages to the one or more control gates, and/or source gates, and/or drain gates;
applying a second voltage to one or more of the one or more source gates;
measuring a signal at one or more of the one or more drain gates;
analysing the measured signal to determine values of one or more parameters; and
interpreting the values of the one or more parameters as non-linear mappings of the input data to be used for the machine learning model.

2. The method of claim 1, wherein transforming the input data into the first voltages includes:
performing a random transform of the input data; and
transforming the random transformed input data into the first voltages.

3. The method of claim 1, wherein transforming the input data into the first voltages includes directly mapping the input data into the first voltages.

4. The method of any one of claim 2 or 3, wherein interpreting the values of the one or more parameters includes combining the values of the one or more parameters as features for the machine learning model.

5. The method of claim 1, wherein:
transforming the input data into the first voltages includes combining data points of the input data into pairs, converting the combined data points into combined voltages; and
applying the first voltages to the one or more control gates comprises applying the combined voltages to the one or more control gates.

6. The method of claim 5, wherein interpreting the values of the one or more parameters includes determining a distance metric or similarity score between the values of the one or more parameters.

7. The method of any one of claims 1-6, wherein the quantum ML device comprising a plurality of source gates, a plurality of drain gates, and a plurality of control gates and the quantum ML device is used as a quantum random kitchen sinks device.

8. The method of any one of claims 1-6, wherein the quantum ML device comprises one source gate, a number of drain gates that matches a desired feature dimension, a number of control gates that matches the dimension of the input data, and the quantum ML device is used as a quantum extreme learning machine.

9. The method of any one of claims 1-6, wherein the quantum ML device comprises one source gate, one drain gate, a number of control gates that is two times the dimension of the input data, and the quantum ML device is used as a quantum kernel learning machine.

10. The method of any one of the preceding claims, further comprising fabricating the quantum ML device, wherein fabricating the quantum ML device comprises:
preparing a bulk layer of a semiconductor substrate;
preparing a second semiconductor layer;
exposing a clean crystal surface of the second semiconductor layer to dopant molecules to produce an array of dopant dots on the exposed surface;
annealing the arrayed surface to incorporate dopant atoms of the dopant molecules into the second semiconductor layer; and
forming the one or more gates, the one or more source leads and the one or more drain leads.

11. The method of claim 10, wherein the one or more control gates are formed in a same plane as the dopant dots.

12. The method of claim 10, further comprising depositing a dielectric material above the second semiconductor layer and the one or more control gates are formed above the dielectric material.

13. The method of any one of claims 10-12, wherein the dopant dots are phosphorus dots.

14. The method of any one of claims 10-12, wherein the second semiconductor layer is silicon-28.

15. A quantum ML device comprising:
one or more quantum dots;
one or more source gates;
one or more drain gates;
and one or more control gates;
wherein the quantum ML device used for generating quantum features for a machine learning model by:
applying first voltages, corresponding to input data for the machine learning model, to the one or more control gates, and/or source gates, and/or drain gates;
applying a second voltage to one or more of the one or more source gates; and
measuring a signal at one or more of the one or more drain gates;
analysing the measured signal to determine values of one or more parameters; and
interpreting the values of the one or more parameters as non-linear mappings of the input data to be used for the machine learning model.

16. The quantum ML device of claim 15, comprising a plurality of source gates, a plurality of drain gates, and a plurality of control gates and the quantum ML device used as a quantum random kitchen sinks device.

17. The quantum ML device of claim 15, comprising one source gate, a number of drain gates that matches a desired feature dimension, a number of control gates that matches dimension of the input data, and the quantum ML device used as a quantum extreme learning machine.

18. The quantum ML device of claim 15, comprising one source gate, one drain gate, a number of control gates that is two times the dimension of the input data, and the quantum ML device is used as a quantum kernel learning machine.

19. The quantum ML device of any one of claims 15-18, wherein the one or more control gates are formed in a same plane as the quantum dots.

20. The quantum ML device of any one of claims 15-19, wherein the quantum dots are phosphorus dots.
